(19) United States
(12) Patent Application Publication
(10) Pub. No.: US 2026/0359763 A1
(43) Pub. Date: Nov. 12, 2026

(54) SYSTEMS AND METHODS FOR IMPROVING WORK PRODUCT

(71) Applicant: ALLSTATE INSURANCE COMPANY, NORTHBROOK, IL (US)

(72) Inventor: Kamal Natarajan, Northbrook, IL (US)

(21) Appl. No.: 19/674,353

(22) Filed: May 12, 2026

Related U.S. Application Data
(60) Provisional application No. 63/804,413, filed on May 12, 2025.

(51) Int. Cl. G06Q 10/0639

(52) U.S. Cl. CPC G06Q 10/0639

(57) ABSTRACT

Computer systems and/or methods for evaluating and improving a quality of work product generated by teams in an enterprise are disclosed. A computing platform may receive a request for work product certification along with one or more work product artifacts. The one or more work product artifacts may include a variety of formats. Using one or more of computer modeling or machine learning techniques, the computing platform may analyze the one or more work product artifacts to generate a score reflecting the quality of the team’s work product. The computing platform may predict and recommend specific actions the team can take to improve work product quality. The computer modeling and/or machine learning techniques may be continuously refined through the analysis of new work product artifacts to enable the computing platform to more accurately evaluate and certify work product quality over time across multiple teams in an enterprise.

### CROSS-REFERENCE TO RELATED APPLICATIONS

This claims priority to U.S. Provisional Patent Application No. 63/804,413, filed on May 12, 2025, the entire contents of which are incorporated by reference herein.

### FIELD

This invention generally relates to computer systems and/or methods for improving work product and/or artifacts corresponding to work product.

### BACKGROUND

Enterprises face significant challenges in efficiently and objectively evaluating whether teams produce high-quality work product that meets business goals, particularly when artifacts exist in multiple formats such as source code, text files, audio recordings, and video files. Traditional certification approaches rely heavily on human experts who manually review diverse artifact types, a process that is time-consuming, computationally intensive, and difficult to scale across multiple teams throughout an enterprise.

Further, conventional methods lack the ability to predict specific actions that would elevate a team's work product quality above predetermined thresholds, requiring iterative human intervention without data-driven guidance. The absence of automated, machine learning-based systems capable of analyzing heterogeneous artifact formats, distinguishing between high-quality and low-quality work product based on historical patterns, and recommending remedial actions creates inefficiencies in the certification process and limits enterprises' ability to systematically improve work product quality across their organizations.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present disclosure provides, in one aspect, a system comprising at least one processor, a communication interface communicatively coupled to the at least one processor, and memory storing computer-readable instructions that, when executed by the at least one processor, cause the at least one processor to: receive a request for certification from a team for one or more work product artifacts, wherein the one or more work product artifacts include one or more formats, analyze, using a certification model trained on one or more historical work product artifacts comprising one or more historical formats, the one or more work product artifacts to determine a score for each work product artifact. The system also includes based on a determination that the score is below a predetermined threshold, predict, using the certification model, one or more actions to increase the score above the predetermined threshold, and generate an output recommending the one or more actions to the team.

The present disclosure provides, in another aspect, a method comprising receiving a request for certification from a team for one or more work product artifacts, wherein the one or more work product artifacts include one or more formats, analyzing, using a certification model trained on one or more historical work product artifacts comprising one or more historical formats, the one or more work product artifacts to determine a score for each work product artifact. The method also includes based on a determination that the score is below a predetermined threshold, predicting, using the certification model, one or more actions to increase the score above the predetermined threshold, and generating an output recommending the one or more actions to the team.

The present disclosure provides, in another aspect, one or more non-transitory computer-readable media storing instructions that, when executed by a processor, cause the processor to receive a request for certification from a team for one or more work product artifacts, wherein the one or more work product artifacts include one or more formats, and analyze, using a certification model trained on one or more historical work product artifacts comprising one or more historical formats, the one or more work product artifacts to determine a score for each work product artifact. The non-transitory computer-readable media instructions also includes based on a determination that the score is below a predetermined threshold, predict, using the certification model, one or more actions to increase the score above the predetermined threshold, and generate an output recommending the one or more actions to the team.

The arrangements described can also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 depicts a computing environment for a certification system according to one or more embodiments.

FIG. 2 depicts components of a computing platform according to one or more embodiments.

FIG. 3 depicts a flow chart illustrating a method for determining a work product certification for one or more teams of an enterprise according to one or more embodiments.

FIG. 4 depicts a flow chart illustrating a method for determining a work product certification for one or more teams of an enterprise using machine learning techniques according to one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Described herein are systems and methods for evaluating whether teams of an enterprise generate high quality work product. In embodiments, the systems and methods may be implemented for employees of the enterprise. For example, the systems and methods described in this disclosure may determine whether teams of the enterprise generate high quality work product that meets the enterprise’s business goals. A team of an enterprise may submit a request to be certified for a quality of their work product. The system and methods described in this disclosure may certify a team on a rating scale or measure the team’s work product relative to a predetermined threshold. The predetermined threshold may be set by the enterprise and may be associated with a level of work product quality. The team may submit one or more artifacts corresponding to work product to be used during the certification process. The one or more artifacts may also be referred to as one or more work product artifacts.

Based on the analysis of the artifacts and comparison to the predetermined threshold, the systems and methods described in this disclosure may determine a certification for the team. The certification may include one or more levels that indicates the team’s quality of work product. The certification may include a scale indicating a level of work product output (e.g., number scale 1-5, or color scale including bronze, silver, gold). The certification may also be referred to as a score or work product score. For example, if the team is above the predetermined threshold, then the systems and methods may generate an output comprising an indication that the team is certified for generating high quality work product. For example, if the team is below the predetermined threshold, then the systems and methods may recommend one or more actions that the team needs to perform to increase their certification above the predetermined threshold. As described in more detail below, the systems and methods may utilize machine learning techniques and/or computer modeling to evaluate artifacts associated with work product and predict actions that increase a team’s certification above the predetermined threshold.

Further, it may take a considerable amount of computing power and time to analyze artifacts comprising a variety of formats (e.g., source code files, text files, videos, audio, recordings, etc.) that may be needed to certify multiple teams across an enterprise. By applying computer model(s) and/or machine learning technique(s) (e.g., machine learning algorithms, artificial intelligence), the systems and methods described in this disclosure may be easily applied to other teams across the enterprise based on analyzing a subset of teams (e.g., rather than analyzing data for the entire enterprise). Applying machine learning techniques to certify teams for generating high quality work product (e.g., work product above a threshold) may reduce the amount of human effort needed during the certification process. Further, by applying machine learning techniques and/or computer modeling, the systems and methods described in this disclosure may predict and recommend actions to a team that needs to increase their certification (or score) above the predetermined threshold. The machine learning techniques and/or computer modeling may be trained with historical data (e.g., work product evaluations, artifacts, certifications, scores, reviews, etc.) to act as a non-human expert in identifying high quality work product as compared to human experts (e.g., technical experts in a field such as software code, human expert not associated with the team requesting certification) evaluating teams for a quality of work product.

### Computing Devices and Operating Environment

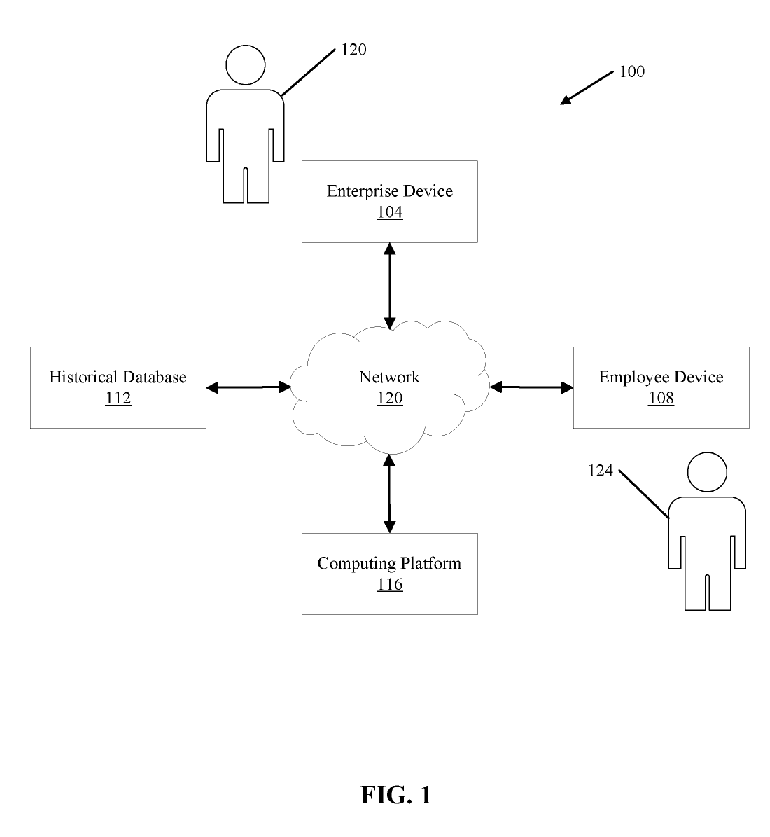

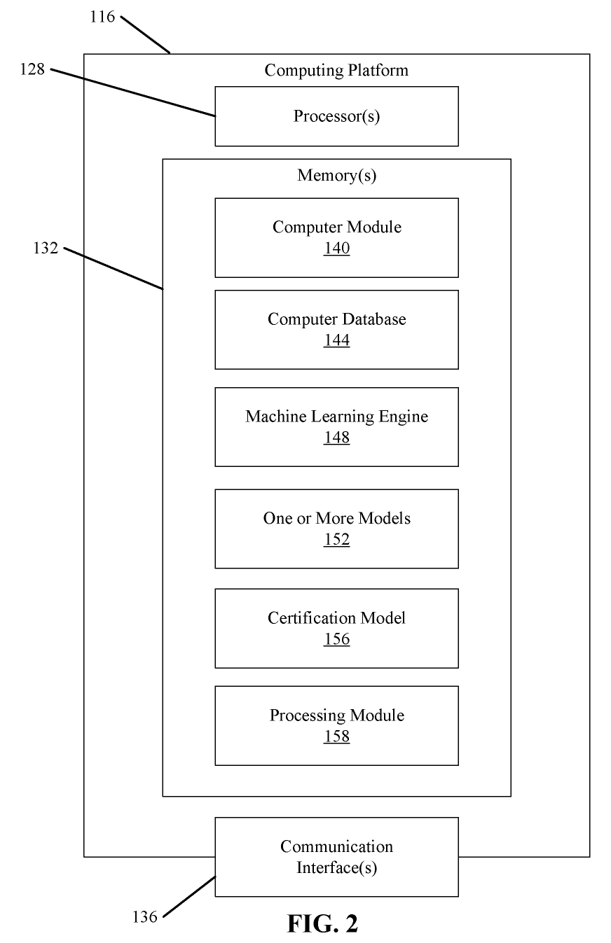

FIGS. 1 and 2 illustrate a computing environment for a system 100 (or certification system 100). The system 100 may determine a work product certification (or score) indicating high quality work product for one or more teams of an enterprise according to one or more embodiments. Referring to FIG. 1, the system 100 may include one or more computing devices. For example, the system 100 may include one or more enterprise devices 104, one or more employee devices 108, a historical database 112, and a computing platform 116.

The enterprise device 104 may be a computing device (e.g., mobile device, smartphone, tablet, desktop computer, laptop computer, or other personal computer device) that may be used by an enterprise human user 120 (e.g., a representative or other employee at an enterprise organization, such as insurance provider). The enterprise human user 120 may be a manager, director, leader, subject matter expert (e.g., software engineer, engineer specialized in a science field), or technical expert of the enterprise. The enterprise device 104 may include other computer components (e.g., processors, memories, communications interfaces). In some embodiments, the enterprise device 104 may be used to identify work product metrics and/or one or more predetermined thresholds to measure work product quality.

The employee device 108 may be a computing device (e.g., mobile device, smartphone, tablet, desktop computer, laptop computer, or other personal computer device) that may be used by a human user 124 (e.g., an employee of the enterprise such as an insurance institution). The employee device 108 may include other computer components (e.g., processors, memories, communications interfaces). In some embodiments, the employee device 108 may be configured to display one or more graphical user interfaces. The employee device 108 may display or notify (e.g., alert or notification) a work product certification (or score) indicating a level of work product quality for review by the human user 124. As described in more detail below, in scenarios where work product may be below a predetermined threshold, the employee device 108 may indicate one or more actions that the human user 124 may need to perform to increase a work product certification (or score) above a predetermined threshold as set by the enterprise.

The historical database 112 may include one or more computers (e.g., laptop computers, desktop computers, server, server blades, or the like), and/or other computer components (e.g., processors, memories, communication interfaces). The historical database 112 may be configured to store and provide historical data indicating historical team output such as historical artifacts corresponding to historical work product. The historical database 112may store one or more historical artifacts in a variety of formats. For example, the historical artifacts may be stored in a first format and a second format, where the first format may be different than the second format. In other embodiments, the variety of formats stored in the historical database 112 may include a first, second, third, fourth, fifth, or any number of formats. For example, the historical artifacts (or historical work product) may comprise source code files, software code, text files, audio files, video files, work product reviews, etc.

The historical database 112 may store one or more predetermined thresholds indicating a level of work product quality. The historical database 112 may include different predetermined thresholds that correspond to different work products or different teams. The historical database 112 may store positive cases indicating historical work product certifications (or scores) that were above the predetermined threshold. The positive cases may includes high quality work product. The positive cases may include work product artifacts above a predetermined threshold. The historical database 112 may store negative cases indicating historical certifications (or scores) that were below the predetermined threshold. The negative cases may include a low or lower quality of work product as compared to previously submitted work product and/or historical work product. The negative cases may include work product artifact(s) below a predetermined threshold. The historical database 112 may also store one or more actions that increase a team’s work product certification (or score) above a predetermined threshold. Further, the historical database 112 may store one or more actions that decrease a team’s work product certification below a predetermined threshold which may be used for training purposes as described in more detail below.

As described in greater detailed below and as shown in FIGS. 1 and 2, the computing platform 116 (or computer platform 116) may include one or more computer devices configured to perform one or more processes described in this disclosure. For example, the computing platform 116 may include one or more computers (e.g., laptop computers, desktop computers, servers, server blades, or the like), and/or other computer components (e.g., processors, memories, communications interfaces). As described in more detail below, the computing platform 116 may perform one or more processes to determine a work product certification (or score) for one or more teams of an enterprise, identify whether a teams’ work product certification (or score) may be above or below a predetermined threshold, and/or predict actions that human user(s) 124 may perform to increase a team’s work product certification (or score) above a predetermined threshold.

With continued reference to FIG. 1, the computing environment may also include one or more networks, which may interconnect the enterprise device(s) 104, the employee device(s) 108, the historical database 112, and the computing platform 116. The computing environment may further interconnect one or more other systems, public networks, sub-networks, and/or the like. For example, the computing environment may include a network 120, where data or information may be transferred between the enterprise device(s) 104, the employee device(s) 108, the historical database 112, and/or the computing platform 116.

In one or more arrangements, the enterprise device(s) 104, the employee device(s) 108, the historical database 112, the computing platform 116, and/or other systems included in the computing environment may be any type of computer device capable of receiving a user interface, receiving input via the user interface, and/or communicating the received input to one or more other computing devices. For example, the system(s) included in the computing environment may, in some examples, be and/or include server computers, desktop computers, laptop computers, tablet computers, mobile devices, smart phones, or the like that may include one or more processors, memories, communication interfaces, storage devices, and/or other components. As noted above, and as illustrated in greater detail below, any and/or all of the enterprise device(s) 104, the employee device(s) 108, the historical database 112, and the computing platform 116 may be special-purpose computer devices configure to perform specific functions.

Referring to FIG. 2, the computing platform 116 may include one or more processors 128, a memory 132, and a communication interface 136. A data bus may interconnect processors 128, the memory 132, and the communication interface 136. The communication interface 136 may be a network interface configured to support communication between the computing platform 116 and one or more networks (e.g., network 120, or the like). The memory 132 may include one or more program modules having instructions that when executed by the processors 128 cause the computing platform 116 to perform one or more functions described herein and/or one or more databases that may store and/or otherwise maintain information which may be used by such program modules and/or processor 128. In some embodiments, the program modules and/or the databases may be stored by and/or maintained in different memory units of the computing platform 116 and/or by different computer devices that may form and/or otherwise make up the computing platform 116.

With continued reference to FIG. 2, the memory 132 may have, store, and/or include a computer module 140, a computer database 144, a machine learning engine 148, and one or more models 152. Computer module 140 may include instructions that direct and/or cause the computing platform 116 to perform the processes described herein. In some embodiments, the computing platform 116 may generate an output comprising a certification of work product quality, a score for one or more work product artifacts, and/or actions that a team may need to perform to increase a certification (or score) for work product above a predetermined threshold.

The computer database 144 may store information used by the computing platform 116, the computer module 140, machine learning engine 148, and/or the one or more models 152 in generating the output. The computer database 144 may store the current data or new data associated with determining work product certifications (or scores) for teams and/or recommending actions to increase work product certifications. The computer database 144 may store historical data associated with determining work product certifications for teams and/or recommending actions to increase work product certifications (or scores). The computer database 144 may receive or send data associated with teams, artifacts, work product quality, work product certifications, certification criteria, actions, etc. from the other computing devices of the system 100 in real-time, continuously, or at intervals.

With continued reference to FIG. 2, the machine learning engine 148 may include instructions that direct and/or cause the computing platform 116 to determine a work product certification (or score), and/or predict actions that teams may need to perform to increase a team’s certification (or score) above a predetermined threshold. The machine learning engine 148 may train one or more models 152 using one or more tools described below. The one or more models 152 may include a certification model 156. For example, as shown in FIG. 2, the machine learning engine 144 may train the certification model 156 to generate a work product certification (or score) for one or more teams of an enterprise. In embodiments, the certification model 156 may generate a score for one or more work product artifacts generated by one or more teams of an enterprise. The work product certification may indicate a level of quality of work product. The certification model 156 may also be trained to predict and recommend actions to teams that need to increase their work product certification above a predetermined threshold. The machine learning engine 148 may set, define, and/or iteratively refine optimization rules, techniques, and/or other parameters used by the computing platform and/or other systems in the computing environment.

The machine learning engine 148 may train the one or more models 152 using historical data. Historical data may be stored in the historical database 114 as described above. The machine learning engine 148 may utilize one or more tools such as, for example, decision tree, support vector machine, random forest, k-means algorithms, gradient boosting algorithms, gradient boosted tree model algorithms, dimensionality reduction algorithms, supervised learning algorithms, unsupervised learning algorithms, regression algorithms (e.g., linear regressions, logistic regression, and the like), instance based algorithms (e.g., learning vector quantization, locally weighted learning, and the like), regularization algorithms (e.g., ridge regression, least-angle regression, and the like), decision tress algorithms, Bayesian algorithms, clustering algorithms, artificial neutral network algorithms, and the like. The one or more models 152 may utilize other machine learning algorithms without departing from the disclosure. Further, the one or more models 152 may be or in communication with large language models, small language, and/or other language models.

Data stored and manipulated in the system 100 (or the computing platform 116) as described herein may be utilized by the machine learning engine 148, which may be able to leverage a cloud computing-based network configuration such as the cloud to apply machine learning and artificial intelligence. The machine learning engine 148 may create models (e.g., model(s) 152) that can be applied by the system 100 to become more efficient and intelligent in execution. In aspects, the system 100 may utilize one or more artificial neural network (ANN) models as understood to those skilled in the art or as yet-to-be-developed to generate communications and alerts as described in aspects herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

The artificial intelligence (AI) models described herein may be used with platforms such as large language models (LLMs), small language models, generative AI, and/or agentic AI based platforms. In embodiments, the systems described herein may be communicatively coupled to and utilize AI such as small language models, large language models (LLMs), transformer models, and/or other generative AI models. LLMs are a type of artificial intelligence model that have been trained through deep learning algorithms to recognize, generate, translate, and/or summarize vast quantities of written human language and textual data. LLMs are a type of generative AI, which is a type of artificial intelligence that uses unstructured deep learning models to produce content based on user input, such as predictive content as described herein. LLMs are considered a specific application of natural language processing that utilize advanced AI algorithms and technologies to generate using generative AI and/or agentic AI believable human text and complete other text-based tasks. Examples of LLMs include OpenAI’s ChatGPT, Nvidia’s NeMO™ LLM, Meta’s LLaMa, and Google’s BERT. Tree-based models may be utilized as supervised machine learning algorithms for classification and regression tasks, such as CART or GBM models. Agentic AI platforms utilize advanced AI algorithms and technologies to go beyond text generation and data analysis to automatically implement and achieve specific tasks and goals without or with limited human supervision.

In embodiments, the machine learning engine 148 may train one or more AI agents, wherein the one or more AI agents may be in communication with the model(s) 152 and/or the certification model 156. The AI agents may also be referred to as virtual agents, non-human agents, or agents formed from one or more of software or hardware components. In embodiments, the model(s) 152 may be trained on specific tasks, specialized tasks, and/or domain-specific data. For example, a first agent of the one or more AI agents may be configured to analyze work product artifact(s) in a first format. For example, the first format may include source code file(s) and/or lines of code. For example, a second agent of the one or more AI agents may be configured to analyze work product artifact(s) in a second format. For example, the second format may include one or more of text file(s), audio file(s), and/or video file(s). The system 100 and/or the computing platform 116 may include any number of AI agents such as a first, second, third, fourth, fifth, sixth, etc. It would be appreciated that the machine learning engine 148 may train any number of AI agents to perform one or more specific tasks regarding analyzing work product artifact(s), scoring work product artifact(s), and/or certifying work product for one or more teams of an enterprise.

In some embodiments, the certification model 156 may be trained to determine a work product certification (or score) for teams based on historical data comprising positive and negative cases. For example, the computing platform 116 may generate the positive cases comprising work product certifications (or scores) for teams that are above the predetermined threshold. The positive cases may comprise work product artifacts associated with high quality work product, and include work product certifications (or scores) that are above a predetermined threshold. For example, the computing platform 116 may generate negative cases comprising work product certifications (or scores) for teams that are below a predetermined threshold. The negative cases may comprise work product artifacts associated with low quality work product, and include work product certifications that are below a predetermined threshold. The certification model 156 may be trained to distinguish between the positive and negative cases to determine work product certifications (or scores) for future teams of an enterprise. Further, the positive and negative cases may be associated with a subset of teams of an enterprise. The certification model 156 and/or model(s) 152 may trained on a subset of data (e.g., work product artifact data, score data, certification data), and be used to analyze work product artifact(s) and determine scores associated with work product quality for other teams of an enterprise.

Further, the machine learning engine 148 may iteratively refine the certification model 156 in response to new work product artifacts, new certification criteria, new work product certifications, new actions, new work product, etc. The certification model 156 may predict work product certifications (or scores) and/or actions for future teams of an enterprise in response to receiving new data. Accordingly, the output of the model(s) 152 and/or the certification model 156 may be confirmed or modified (e.g., by human, AI agents, other model(s), other algorithms, software components, hardware components), and this may form additional training data for the certification model 156 and/or the machine learning engine 148.

As shown in FIG. 2, the computing platform 116 may include a processing module 158. The processing module 158 may also be referred to as a pre-processing, transformation, work product artifact transformation, and/or conversion module. The processing module 158 may be configured to convert (or transform) one or more artifacts corresponding to work product into a standardized (or unified, or structured) format. The one or more artifacts may also be referred to as one or more work product artifacts. In embodiments, the processing module 158 may be configured to convert (or transform) unstructured data in artifact(s) corresponding to work product into a structured data. In other words, the processing module 158 may be configured to convert (or transform) heterogeneous formats of one or more artifacts corresponding to work product into a standardized (or unified) format. The standardized format may allow the certification model 156 to analyze one or more work product artifacts to determine one or more scores corresponding to the work product artifact(s).

In embodiments, the processing module 158 may include one or more of tokenization or vector embedding function. In embodiments, the processing module 158 may utilize tokenization and/or vector embedding for work product artifact(s) comprising text and/or code files. For example, the processing module 158 may perform one or more tokenization actions to convert sensitive or complex data in work product artifact(s) into manageable (or smaller, or non-sensitive) units that may be used by one or more components of the computing platform 116. For example, the processing module 158 may perform one or more vector embedding actions to convert data in work product artifact(s) into one or more arrays of numbers or other arrays. In other words, the processing module 158 may perform one or more vector embedding actions to convert data in work product artifact(s) into structured, machine-readable data (or machine-readable format).

In embodiments, the processing module 158 may include audio and/or visual feature extraction functions. In embodiments, the processing module 158 may utilize audio and/or visual feature extraction for work product artifact(s) comprising audio and/or video files(s). For example, the processing module 158 may analyze audio file(s) for keywords related to software-based products or services. For example, the processing module 158 may analyze audio file(s) for keywords associated with source code file(s), or software code indicators (e.g., Javascript, type of software code, front end, back end, software code syntax, etc.). For example, the processing module 158 may analyze video file(s) to extract visual indicators of work product. For example, the processing module 158 may analyze video file(s) to identify generation of source code file(s) including one or more lines of code, identify line(s) of code associated with one or more software-based product(s) or service(s), partner programing, or pair programming (e.g., two or more humans writing software code, two or more AI agents writing software code, or two or more models generating software code).

The certification model 156 may include one or more algorithms that score the work product artifact(s). Work product artifact score(s) may be on a scale (e.g., number scale 1-10, letter scale A-F). The certification model 156 may analyze work product artifact(s) to determine whether a score exceeds or is below a predetermined threshold (e.g., set by an enterprise team, organization of an enterprise). For example, the score threshold may indicate a quality of work product or a functionality of a work product. For example, work product artifact(s) that are above a score threshold may indicate work product artifact(s) comprising source code file(s) that increase or improve functionalities of a software-based products or services. For example, work product artifact(s) that are below a score threshold may indicate work product artifact(s) comprising source code file(s) that produce one or more errors in the functionality of a software-based products or services. In embodiments, the certification model 156 may score work product artifact(s) comprising source code file(s) with one or more lines of code higher than text file(s) that include a high-level software architecture (e.g., no or minimal lines of code). In other words, the certification model 156 may score work product artifact(s) comprising actual work product (e.g., lines of code, software packages, models, algorithms) that may be operational with software-based products or services higher than high-level software architecture schematics with no or minimal lines of code.

The certification model 156 may further include weighting schemes and/or weighting algorithms for work product artifact(s) when determining score(s) associated with certification of work product artifact(s) or team(s) of an enterprise. The certification model 156 may weigh one or more work product artifacts based on one or more formats corresponding to the work product artifact(s). In embodiments, the certification model 156 may weigh artifact types or formats differently as compared to other artifact(s) types or formats. For example, the certification model 156 may weigh artifact(s) comprising source code files (e.g., Javascript, etc.) more than text files indicating work product, and/or vice-versa. For example, the certification model 156 may weigh work product artifact(s) comprising audio file(s), text file(s), video file(s), source code file(s), etc. when evaluating or certifying work product artifact(s). It would be appreciated that other combinations of weightings for work product artifact(s) may be contemplated without departing from the scope of the disclosure.

### Determine Work Product Certifications for One or More Teams of an Enterprise

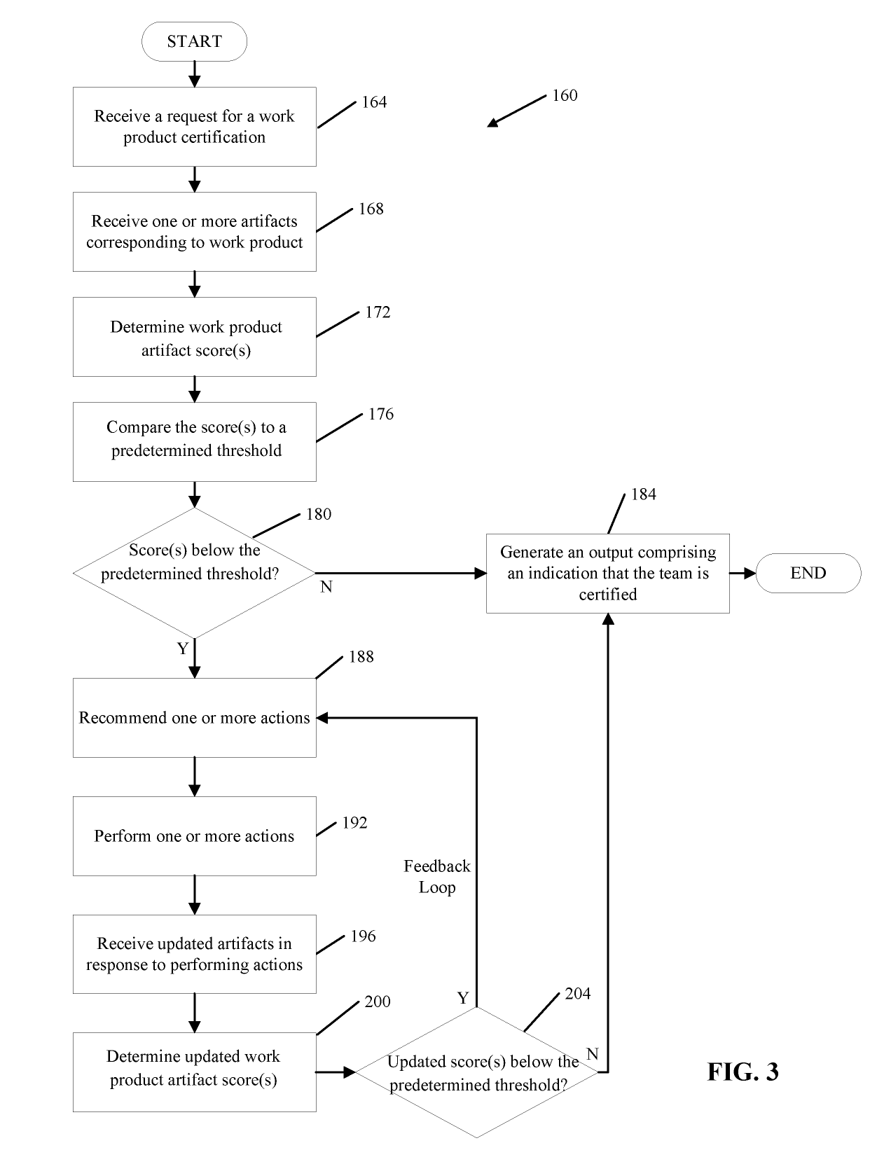

FIG. 3 depicts a flow chart including a method 160 (or process 160) for determining work product certifications for one or more teams of an enterprise according to one or more embodiments. Some or all of the steps of method 160 may be performed using one or more computer devices and/or combination thereof described in this disclosure. Some or all the steps of method 160 may be performed in series, parallel, independently, separately, simultaneously, asynchronously, and/or any combination thereof. Some or all the steps of method 160 may be performed with the method 210 described in more detail below. In a variety of embodiments, some or all of the steps described below may be combined and/or divided into sub-steps as appropriate.

Referring to FIG. 3, at step 164, a computing platform 116 having at least one processor 128, a communication interface 136, and a memory 132 may receive a request for a work product certification from a team of an enterprise. The work product certification may also be referred to as determining whether a score corresponding to one or more work product artifacts are above or below a predetermined threshold. In embodiments, the work product certification may correspond to determining one or more scores for one or more work product artifact generated by the team. At step 168, the computing platform 116 may receive one or more work product artifacts generated by the team. The one or more work product artifacts may comprise a first work product artifact in a first format and a second work product artifact in a second format. The one or more work product artifacts may comprise any number work product artifacts in a variety of formats. In some embodiments, the format of the work product artifact(s) may comprise a software code, source code file, a text file, an audio file, and/or a video file.

At step 172, the computing platform 116 may determine the work product certification based on the received one or more work product artifacts. The computing platform 116 may determine one or more scores corresponding to the work product artifact(s) generated by the team. The one or more scores may also be referred to as work product artifact score(s). The computing platform 116 may analyze the one or more work product artifacts to determine the one or more scores as described in this disclosure. The computing platform 116 may utilized the one or more models 152 such as the certification model 156 described above to analyze the work product artifact(s). Analyzing the one or more work product artifacts may directly result in the output (e.g., from the certification model 152) of the score(s) corresponding to the work product artifact(s).

Additionally, or alternatively, at step 172, the computing platform 116 may determine an individual score for each work product artifact. The computing platform 116 may aggregate the individual scores for the one or more work product artifacts to determine an overall work product artifact score. The scores(s) and/or the overall work product artifact score may include a scale indicating a quality level for the work product (e.g., number scale 1-5, or color scale including bronze, silver, gold). The aggregated work product artifact score may be utilized to determine the certification for the team.

At step 176, the computing platform 116 may compare the work product artifact score(s) to a predetermined threshold. The predetermined threshold may be set by the enterprise of the team, one or more individuals associated with the team, or other organizations in the enterprise. The predetermined threshold may indicate a quality level for work product artifact(s). For example, the predetermined threshold may include a numerical metric representing a quality level for work product artifact(s). As another example, the predetermined threshold may include a metric that may measure a quality level for work product artifact(s).

At step 180, the computing platform 116 may determine whether the work product artifact score(s) are above or below a predetermined threshold. If the computing platform 116 determines the work product artifact score(s) are above the predetermined threshold, then at step 184, the computing platform 116 may generate an output indicating that the team obtained certification. In some embodiments, the output may include an alert or indication that may be displayed on a graphical user interface of the employee device 108.

Alternatively, at step 188, if the computing platform 116 determines the work product artifact score(s) is below the predetermined threshold, then the computing platform 116 may recommend one or more actions to increase the work product artifact score(s) above the predetermined threshold. For example, the one or more actions may include a review of work product artifact(s) by a technical expert, a review of the work product artifact(s) by someone outside the team, a review of the work product artifact(s) by an individual not associated with team, a coaching session, a meeting, team building exercise, attending a class, a pair programming session, etc. The one or more actions may comprise actions that improve the quality of the work product. In embodiments, the one or more actions may comprise action(s) that increase a score associated with the work product artifact(s) above a predetermined threshold. In embodiments, the one or more actions may comprise action(s) that modify, change, or revise software code in the work product artifact(s). For example, the one or more actions may include modifying software code to remove or reduce errors to improve the functionality of software-based product(s) or service(s).

At step 192, the employees (e.g., human users 124) of the team may perform the one or more actions recommended at step 188. In embodiments, the computing platform 116 and/or the model(s) 152 (e.g., certification model 156) may automatically perform the one or more actions recommended at step 188. In embodiments, the computing platform 116 and/or the model(s) 152 (e.g., certification model 156) may automatically generate one or more updated work product artifact(s) based on the one or more actions recommended at step 188. For example, the computing platform 116 may determine one or more actions associated with modifying software code and implement the modifications to the work product artifact(s) (e.g., software-based product or service). In embodiments, the computing platform 116 and/or model(s) 152 (e.g., certification model 156) may implement one or more machine learning techniques as described in this disclosure to automatically perform the one or more actions and generate updated work product artifact(s).

At step 196, the computing platform 116 may receive updated work product artifact(s) based on the performed one or more actions recommended at step 188. In embodiments, the computing platform 116 and/or model(s) 152 (e.g., certification model 156) may generate updated work product artifact(s) based on the one or more actions. The updated work product artifact(s) may be generated by the team after performing the recommended one or more actions. At step 200, the computing platform 116 may determine updated work product score(s) for the updated work product artifact(s). At step 204, the computing platform 116 may determine whether the updated work product artifact score(s) are above or below a predetermined threshold. The computing platform 116 may compare the updated work product artifact score(s) to a predetermined threshold. In embodiments, the computing platform 116 may compare the updated work product artifact score(s) to a predetermined threshold.

If the work product artifact score(s) are below the predetermined threshold, then the system 100 may repeat steps 188, 192, 196, and 200 until the team generates updated work product artifact(s) that achieve a score above the predetermined threshold. The system 100 may perform one or more work product certifications or work product artifact scoring over a period of time to determine whether the work product artifact score(s) is above the predetermined threshold. If the computing platform 116 determines the updated work product artifact score(s) is above the predetermined threshold, then the system 100 returns to step 184 to generate an output indicating the team has obtained certification for their work product or work product artifact(s).

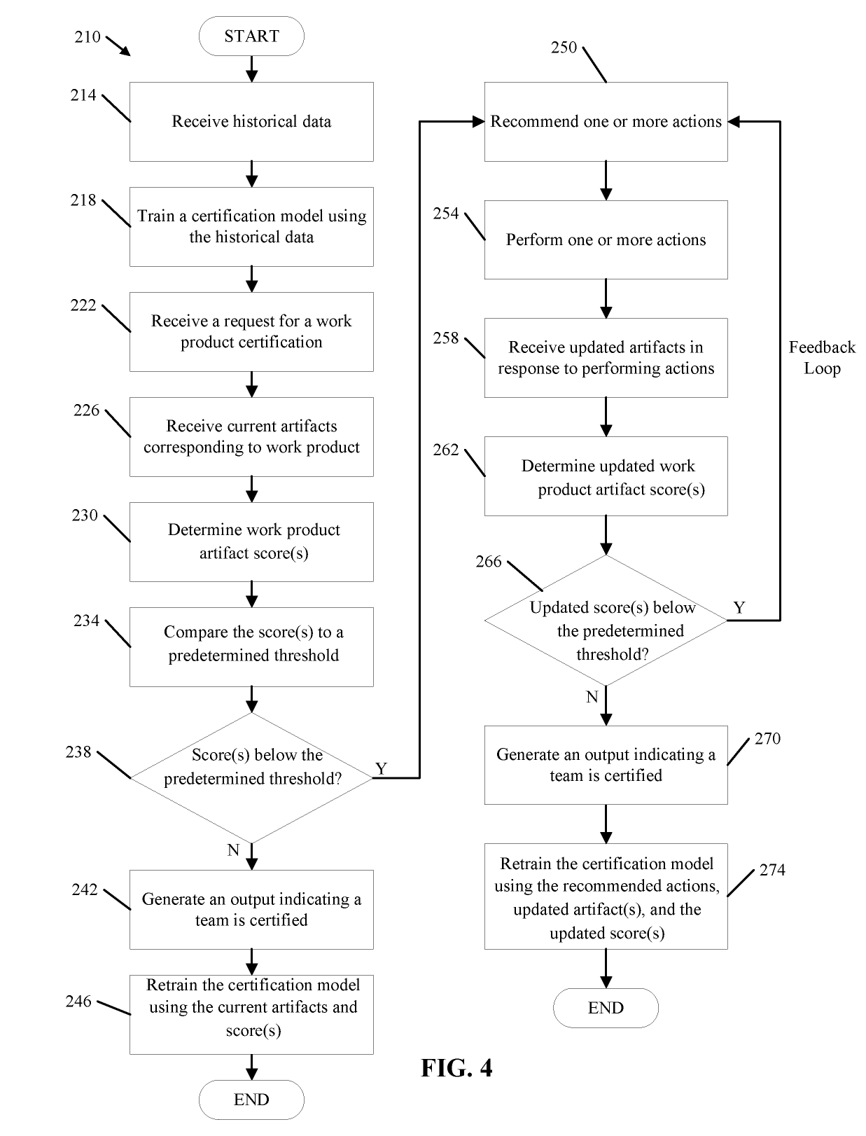

FIG. 4 depicts a flow chart including a method 210 (or process 210) for determining a work product certification for one or more teams of an enterprise using machine learning techniques according to one or more embodiments. Some or all of the steps of method 210 may be performed using one or more computer devices and/or combination thereof described in this disclosure. Some or all the steps of method 210 may be performed in series, parallel, independently, separately, simultaneously, asynchronously, and/or any combination thereof. Some or all the steps of method 210 may be performed with the method 160 described above. In a variety of embodiments, some or all of the steps described below may be combined and/or divided into sub-steps as appropriate.

Referring to FIG. 4, at step 214, a computing platform 116 having at least one processor 128, a communication interface 136, and a memory 132 may receive historical data from one or more computing devices in the system 100. For example, the computing platform 116 may receive historical data from the historical database 112. At step 218, the computing platform 116 may train the certification model 156 using the historical data and the machine learning engine 148. For example, the historical data may include historical work product artifact(s), historical work product artifact score(s), and/or historical work product certifications.

The machine learning engine 148 may utilize one or more tools to train the certification model 156 as described in this disclosure. In embodiments, the machine learning engine 148 may initiate one or more communications between the certification model 156 and one or more language models to perform one or more processes associated with certifying a team based on work product quality, and/or scoring one or more work product artifacts. Once a tool is selected and/or communication is established, the computing platform 116 may create positive and negative cases for training (e.g., label the historical data as positive or negative, label historical work product artifact(s) as above or below a predetermined threshold). For example, in creating the positive cases, the computing platform 116 may identify one or more work product artifacts that correspond with a score above a predetermined threshold (e.g., artifacts that indicate high work product quality, work product with high quality, or quality is above a predetermined threshold). In creating the negative cases, the computing platform 116 may identify one or more work product artifacts that correspond with a score below a predetermined threshold (e.g., artifacts that indicate a lower work product quality, work product with low quality, or quality is below a predetermined threshold). The computing platform 116 may train the certification model 156 using the machine learning engine 148 to distinguish between the positive and negative cases. The computing platform 116 may train the certification model 156 to predict scores based on new work product artifacts, and/or predict actions that increase work product artifact(s) above a predetermined threshold.

Further, based on scenarios where the work product artifact score is below a predetermined threshold, the machine learning engine 184 may train the certification model 156 to predict actions that increase the work product artifact scores above a predetermined threshold. The computing platform 116 may create positive and negative cases for training. For example, in creating positive cases, the computing platform 116 may identify one or more actions that resulted in increasing the work product artifact score(s). In creating negative cases, the computing platform 116 may identify one or more actions that resulted in decreasing the work product artifact score(s). The computing platform 116 may train the certification model 156 using the machine learning engine 148 to distinguish between the positive and negative cases. The computing platform 116 may train the certification model 156 to predict actions that increase work product certifications above a predetermined threshold based on new artifacts and new work product certifications.

With continued reference to FIG. 4, at step 222, may receive a request for a work product certification from a team of an enterprise. At step 226, the computing platform 100 may receive one or more work product artifacts generated by the team. At step 230, the computing platform 100 may determine one or more scores for one or more work product artifacts generated by the team. The computing platform 116 may analyze the one or more work product artifacts. For example, the computing platform 116 may utilize the certification model 156 to analyze the one or more work product artifacts. Analyzing the one or more work product artifacts may directly result in the output (e.g., from the certification model 152) of one or more scores corresponding to one or more work product artifacts. In some embodiments, the computing platform 116 may determine an individual score for each work product artifact. The computing platform 116 may aggregate the individual scores for the one or more work product artifacts to generate an overall work product artifact score. The work product artifact score(s) and/or the overall work product artifact score may include a scale indicating a level of work product quality (e.g., number scale 1-5, or color scale including bronze, silver, gold).

At step 234, the computing platform 116 may compare the work product artifact score(s) to a predetermined threshold. The predetermined threshold may be set by the enterprise of the team. The predetermined threshold may indicate a level of quality for the work product.

At step 238, the computing platform 116 may determine whether the work product artifact score(s) is above or below a predetermined threshold. If the computing platform 116 determines the work product artifact score(s) is above the predetermined threshold, then at step 242, the computing platform 116 may generate an output indicating that the team obtained certification. In some embodiments, the output including the indication may be displayed on a graphical user interface of the employee device 108.

At step 246, the computing platform 116 may store the certification determined at step 230, the predetermined threshold used in the analysis, and/or the work product artifact(s) used to determine the work product artifact score(s) and the team certification in a database such as the historical database 112. At step 246, the computing platform 116 may retrain the certification model 156 using the new data including the work product artifact(s), predetermined threshold(s), work product artifact score(s), and/or work product certification(s) to further refine the certification model 156 for future requests corresponding to certifications of work product and/or work product artifact(s).

Alternatively, if the computing platform 116 determines the work product artifact score(s) is below the predetermined threshold, then at step 250, the computing platform 116 may recommend one or more actions to increase the work product artifact score(s) above the predetermined threshold. The computing platform 116 may use the certification model 156 to predict actions that may increase the work product artifact score(s) above the predetermined threshold. The certification model 156 may be trained to predict actions for increasing work product artifact score(s) as described in this disclosure. In embodiments, the one or more actions may require a modification, update, revision, and/or change to work product artifact(s). For example, the one or more actions may include modification or revision of lines of code in a source code file to remove errors and/or improve the functionality of a software-based product or service. For example, the one or more actions may include a review of work product artifact(s) by a subject matter technical expert, a review of the work product artifact(s) by an individual outside the team, a review of work product artifact(s) by an individual not associated with the team, a coaching session, a meeting, team building exercise, attending a class, etc. The one or more actions may comprise actions that improve the quality of work product. The one or more actions may comprise actions that increase work product artifact score(s) above a predetermined threshold.

At step 254, the employees (e.g., human users 124) of the team may perform the one or more actions recommended at step 250. At step 258, the computing platform 116 may receive updated work product artifact(s) in response to the employees performing the actions. At step 262, the computing platform 116 may determine updated work product artifact score(s) for the updated work product artifact(s). At step 266, the computing platform 116 may determine whether the work product artifact score(s) is above or the below the predetermined threshold. If the work product artifact score(s) is below the predetermined threshold, then the system 100 may repeat steps 250, 254, 258, and 262 until the team generates updated work product artifact(s) that achieve work product artifact score(s) above the predetermined threshold. If the computing platform 116 determines the updated work product artifact score(s) is above the predetermined threshold, then at step 270, the computing platform 116 may generate an output indicating the team obtained the work product certification above the predetermined threshold.

At step 274, the computing platform 116 may store the updated work product artifact score(s) and/or certification at step 262, the predetermined threshold used in the analysis, and/or the updated work product artifact(s) used to determine the certification in one or more databases such as the historical database 112. The computing platform 116 may retrain the certification model 156 using the new data including the updated work product artifact(s), updated work product artifact score(s), team certification, and/or recommended actions to further refine the certification model 156 for future requests received from a team of an enterprise to certify their work product and/or work product artifact(s).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of “at least one” component, element, etc., should not be used to create an inference that the alternative use of articles “a” or “an” should be limited to a single component, element, etc. It is further noted that recitations herein of “a”, “an”, “the”, “at least one”, and “one or more” are used interchangeably to indicate that at least one of the item is present and a plurality of such items may be present unless the context clearly indicates otherwise. It is also noted that recitations herein of a component of the present disclosure being “configured” or “programed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilized the term “wherein” as a transitional phrase. For the purposes of defining the present disclosure, it noted that his term is an open-ended transitional term that is used to introduce a recitation of a series of characteristics of the structure and should be interpreted in like manner as the more commonly used open-ended preamble term “comprising.”

### Representative Features

Representative features are set out in the following clauses, which stand alone or may be combined, in any combination, with one or more features disclosed in the text, and/or drawings of the specification.

Clause 1. A system comprising: at least one processor; a communication interface communicatively coupled to the at least one processor; and memory storing computer-readable instructions that, when executed by the at least one processor, cause the at least one processor to: receive a request for certification from a team for one or more work product artifacts, wherein the one or more work product artifacts include one or more formats; analyze, using a certification model trained on one or more historical work product artifacts comprising one or more historical formats, the one or more work product artifacts to determine a score for each work product artifact; and based on a determination that the score is below a predetermined threshold, predict, using the certification model, one or more actions to increase the score above the predetermined threshold, and generate an output recommending the one or more actions to the team.

Clause 2. The system of Clause 1, wherein the one or more actions comprise at least one of: a technical expert review of the one or more work product artifacts, a review of the one or more work product artifacts by an individual not associated with the team, a coaching session, or a training class.

Clause 3. The system of any of Clause 1 to Clause 2, further comprising: receive one or more updated work product artifacts based on performing the one or more actions by the team; determine, using the certification model, an updated score for each updated work product artifact; and determine, using the certification model, whether the updated score is above or below the predetermined threshold.

Clause 4. The system of any of Clause 1 to Clause 3, wherein the one or more formats include a source code file, a text document, an audio recording, a video recording, or an image.

Clause 5. The system of any of Clause 1 to Clause 4, wherein the certification model applies one or more weights to the one or more work product artifacts based on the one or more formats.

Clause 6. The system of any of Clause 1 to Clause 5, wherein the one or more work product artifacts comprise a source code file and a text document, wherein the certification model applies a first weight to the source code file and a second weight to the text document, and wherein the first weight is different than the second weight.

Clause 7. The system of any of Clause 1 to Clause 6, further comprising: receive first training data including at least one historical work product artifact of the one or more historical work product artifacts above the predetermined threshold; receive second training data including at least one historical work product artifact of the one or more historical work product artifacts below the predetermined threshold; and train the certification model using the first training data and the second training data.

Clause 8. The system of any of Clause 1 to Clause 7, further comprising: generate, via a graphical user interface and based on the score is above the predetermined threshold, an indication that the team obtained certification for the one or more work product artifacts.

Clause 9. A method comprising: receiving a request for certification from a team for one or more work product artifacts, wherein the one or more work product artifacts include one or more formats; analyzing, using a certification model trained on one or more historical work product artifacts comprising one or more historical formats, the one or more work product artifacts to determine a score for each work product artifact; and based on a determination that the score is below a predetermined threshold, predicting, using the certification model, one or more actions to increase the score above the predetermined threshold, and generating an output recommending the one or more actions to the team.

Clause 10. The method of Clause 9, wherein the one or more actions comprise at least one of: a technical expert review of the one or more work product artifacts, a review of the one or more work product artifacts by an individual not associated with the team, a coaching session, or a training class.

Clause 11. The method of any of Clause 9 to Clause 10, further comprising: receiving one or more updated work product artifacts based on performing the one or more actions by the team; determining, using the certification model, an updated score for each updated work product artifact; and determining, using the certification model, whether the updated score is above or below the predetermined threshold.

Clause 12. The method of any of Clause 9 to Clause 11, wherein the one or more formats include a source code file, a text document, an audio recording, a video recording, or an image.

Clause 13. The method of any of Clause 9 to Clause 12, wherein the certification model applies one or more weights to the one or more work product artifacts based on the one or more formats.

Clause 14. The method of any of Clause 9 to Clause 13, further comprising: receiving first training data including at least one historical work product artifact of the one or more historical work product artifacts above the predetermined threshold; receiving second training data including at least one historical work product artifact of the one or more historical work product artifacts below the predetermined threshold; and training the certification model using the first training data and the second training data.

Clause 15. One or more non-transitory computer-readable media storing instructions that, when executed by a processor, cause the processor to: receive a request for certification from a team for one or more work product artifacts, wherein the one or more work product artifacts include one or more formats; analyze, using a certification model trained on one or more historical work product artifacts comprising one or more historical formats, the one or more work product artifacts to determine a score for each work product artifact; and based on a determination that the score is below a predetermined threshold, predict, using the certification model, one or more actions to increase the score above the predetermined threshold, and generate an output recommending the one or more actions to the team.

Clause 16. The non-transitory computer-readable media storing instructions of Clause 15, wherein the one or more actions comprise at least one of: a technical expert review of the one or more work product artifacts, a review of the one or more work product artifacts by an individual not associated with the team, a coaching session, or a training class.

Clause 17. The non-transitory computer-readable media storing instructions of any of Clause 15 to Clause 16, wherein when executed by the processor, cause the processor to: receive one or more updated work product artifacts based on performing the one or more actions by the team; determine, using the certification model, an updated score for each updated work product artifact; and determine, using the certification model, whether the updated score is above or below the predetermined threshold.

Clause 18. The non-transitory computer-readable media storing instructions of any of Clause 15 to Clause 17, wherein the one or more formats include a source code file, a text document, an audio recording, a video recording, or an image.

Clause 19. The non-transitory computer-readable media storing instructions of any of Clause 15 to Clause 18, wherein the certification model applies one or more weights to the one or more work product artifacts based on the one or more formats.

Clause 20. The non-transitory computer-readable media storing instructions of any of Clause 15 to Clause 19, wherein when executed by the processor, cause the processor to: receive first training data including at least one historical work product artifact of the one or more historical work product artifacts above the predetermined threshold; receive second training data including at least one historical work product artifact of the one or more historical work product artifacts below the predetermined threshold; and train the certification model using the first training data and the second training data.

Aspects of the disclosure have been described in terms of illustrative embodiment thereof. Numerous other embodiments, modifications, and variations within the scope and spirit of the appended claims will occur to persons of ordinary skill in the art from a review of this disclosure. For example, one or more steps depicted in the illustrative figures may be performed in a different order other than the recited order, and one or more depicted steps may be optional in accordance with aspects of the disclosure.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
at least one processor;
a communication interface communicatively coupled to the at least one processor; and
memory storing computer-readable instructions that, when executed by the at least one processor, cause the at least one processor to:
receive a request for certification from a team for one or more work product artifacts, wherein the one or more work product artifacts include one or more formats;
analyze, using a certification model trained on one or more historical work product artifacts comprising one or more historical formats, the one or more work product artifacts to determine a score for each work product artifact; and
based on a determination that the score is below a predetermined threshold, predict, using the certification model, one or more actions to increase the score above the predetermined threshold, and generate an output recommending the one or more actions to the team.

2. The system of claim 1, wherein the one or more actions comprise at least one of: a technical expert review of the one or more work product artifacts, a review of the one or more work product artifacts by an individual not associated with the team, a coaching session, or a training class.

3. The system of claim 1, further comprising:
receive one or more updated work product artifacts based on performing the one or more actions by the team;
determine, using the certification model, an updated score for each updated work product artifact; and
determine, using the certification model, whether the updated score is above or below the predetermined threshold.

4. The system of claim 1, wherein the one or more formats include a source code file, a text document, an audio recording, a video recording, or an image.

5. The system of claim 1, wherein the certification model applies one or more weights to the one or more work product artifacts based on the one or more formats.

6. The system of claim 5, wherein the one or more work product artifacts comprise a source code file and a text document, wherein the certification model applies a first weight to the source code file and a second weight to the text document, and wherein the first weight is different than the second weight.

7. The system of claim 1, further comprising:
receive first training data including at least one historical work product artifact of the one or more historical work product artifacts above the predetermined threshold;
receive second training data including at least one historical work product artifact of the one or more historical work product artifacts below the predetermined threshold; and
train the certification model using the first training data and the second training data.

8. The system of claim 1, further comprising:
generate, via a graphical user interface and based on the score is above the predetermined threshold, an indication that the team obtained certification for the one or more work product artifacts.

9. A method comprising:
receiving a request for certification from a team for one or more work product artifacts, wherein the one or more work product artifacts include one or more formats;
analyzing, using a certification model trained on one or more historical work product artifacts comprising one or more historical formats, the one or more work product artifacts to determine a score for each work product artifact; and
based on a determination that the score is below a predetermined threshold, predicting, using the certification model, one or more actions to increase the score above the predetermined threshold, and generating an output recommending the one or more actions to the team.

10. The method of claim 9, wherein the one or more actions comprise at least one of: a technical expert review of the one or more work product artifacts, a review of the one or more work product artifacts by an individual not associated with the team, a coaching session, or a training class.

11. The method of claim 9, further comprising:
receiving one or more updated work product artifacts based on performing the one or more actions by the team;
determining, using the certification model, an updated score for each updated work product artifact; and
determining, using the certification model, whether the updated score is above or below the predetermined threshold.

12. The method of claim 9, wherein the one or more formats include a source code file, a text document, an audio recording, a video recording, or an image.

13. The method of claim 9, wherein the certification model applies one or more weights to the one or more work product artifacts based on the one or more formats.

14. The method of claim 9, further comprising:
receiving first training data including at least one historical work product artifact of the one or more historical work product artifacts above the predetermined threshold;
receiving second training data including at least one historical work product artifact of the one or more historical work product artifacts below the predetermined threshold; and
training the certification model using the first training data and the second training data.

15. One or more non-transitory computer-readable media storing instructions that, when executed by a processor, cause the processor to:
receive a request for certification from a team for one or more work product artifacts, wherein the one or more work product artifacts include one or more formats;
analyze, using a certification model trained on one or more historical work product artifacts comprising one or more historical formats, the one or more work product artifacts to determine a score for each work product artifact; and
based on a determination that the score is below a predetermined threshold, predict, using the certification model, one or more actions to increase the score above the predetermined threshold, and generate an output recommending the one or more actions to the team.

16. The non-transitory computer-readable media storing instructions of claim 15, wherein the one or more actions comprise at least one of: a technical expert review of the one or more work product artifacts, a review of the one or more work product artifacts by an individual not associated with the team, a coaching session, or a training class.

17. The non-transitory computer-readable media storing instructions of claim 15, wherein when executed by the processor, cause the processor to:
receive one or more updated work product artifacts based on performing the one or more actions by the team;
determine, using the certification model, an updated score for each updated work product artifact; and
determine, using the certification model, whether the updated score is above or below the predetermined threshold.

18. The non-transitory computer-readable media storing instructions of claim 15, wherein the one or more formats include a source code file, a text document, an audio recording, a video recording, or an image.

19. The non-transitory computer-readable media storing instructions of claim 15, wherein the certification model applies one or more weights to the one or more work product artifacts based on the one or more formats.

20. The non-transitory computer-readable media storing instructions of claim 15, wherein when executed by the processor, cause the processor to:
receive first training data including at least one historical work product artifact of the one or more historical work product artifacts above the predetermined threshold;
receive second training data including at least one historical work product artifact of the one or more historical work product artifacts below the predetermined threshold; and
train the certification model using the first training data and the second training data.
